(19) United States
(12) Patent Application Publication
(10) Pub. No.: US 2006/0075641 A1
(43) Pub. Date: Apr. 13, 2006

(54) Powered grass shear

(76) Inventors: John R. Nottingham, Bratenahl, OH (US); John W. Spirk, Gates Mills, OH (US); John W. Nottingham, Bratenahl, OH (US); Marc L. Vitantonio, South Russell, OH (US)

Correspondence Address: DKW LAW GROUP, P.C., 58TH FLOOR - USX TOWER, 600 GRANT STREET, PITTSBURGH, PA, 15219, US

(21) Appl. No.: 11/247,041

(22) Filed: Oct. 11, 2005

Related U.S. Application Data
(60) Provisional application No. 60/617,272, filed on Oct. 8, 2004.

(51) Int. Cl. B23D 21/06

(52) U.S. Cl. 30/100

(57) ABSTRACT

An electric grass shear has a safety button linked to a power switch for the shear, such that the safety button must be pressed before the power switch can be actuated to allow electric current to flow to a motor. In one embodiment, the grass shear is packaged for sale in a sealed package having a feature that permits a prospective purchaser to momentarily operate the shear while it is still in the package. In another embodiment, the grass shear is provided with a wheeled extension handle to which the shear can be mounted to allow a user to use the shear while standing.

### CROSS-REFERENCE TO RELATED APPLICATIONS

This application claims the benefit of U.S. Provisional Patent Application Ser. No. 60/617,272, filed Oct. 8, 2004.

### BACKGROUND OF THE INVENTION

1. Field of the Invention

The present invention generally relates to electric devices for trimming grass, especially grass shears.

2. Description of Related Art

A known type of powered grass shear comprises a battery-powered motor mounted on a vertical axis within a housing designed to be held by a user in one hand; a fixed blade having forwardly-projecting, laterally spaced-apart teeth mounted on the front of the housing; and a movable blade, also having forwardly-projecting, laterally spaced-apart teeth, superimposed over the fixed blade and linked to the motor by power transmission means, typically including a gear or a set of gears. The motor drives the power transmission means, which converts the rotary motion of the motor to oscillatory motion and transmits that motion to the movable blade, causing it to oscillate rapidly from side-to-side over the fixed blade, cutting grass between the forwardly-projecting teeth of the blades as the teeth of the movable blade cross those of the fixed blade. In some models, the power transmission means drives the movable blade forward and backward from the rear while causing it to pivot about a pivot point in the middle, producing an arcuate, reciprocating motion.

The flow of electric current from the batteries to the motor is generally controlled by a power switch conveniently located on the housing. One danger of such shears is that the power switch may be actuated by a child or inadvertently actuated by an adult user.

### SUMMARY OF THE INVENTION

Accordingly, it is an objective of the present invention to provide an electrically-powered grass shear having a safety button that must be pressed in addition to the power switch in order to turn on the motor. Another objective of the present invention is to provide such a shear with a raised collar around the power switch to guard against accidental actuation of the switch. A third objective of the present invention is to provide such a shear that is comfortable to hold and easy to operate. Another objective of the present invention is to provide such a shear in a sealed package that allows a potential purchaser to activate the shear in the package in order to observe its operation before purchasing it. Yet another objective is to provide such a shear with a wheeled extension handle that allows a user to clip grass at the ground level while standing upright.

Accordingly, the present invention provides an electrically-powered, motor-driven grass shear having a fixed multi-tooth blade and a movable multi-tooth blade that oscillates laterally or in an arcuate, reciprocating motion across the fixed blade in order to cut grass (or other grass-like material) between the teeth. The shear has a handle grip with a power switch and a safety button, both of which must be actuated in order to start the motor. The housing includes a raised collar that surrounds the power switch in order to prevent accidental actuation of the power switch. The present invention also provides an optional wheeled extension handle that can be removably attached and electrically linked to the shear, such that the shear may be used while the user is standing. The present invention further provides a sealed package for the grass shear, which is packaged with batteries installed.

The package includes a transparent blister and holds the shear in such a way that the safety button is constantly depressed in the package. The power switch is covered by a deformable transparent blister, so that a potential purchaser can actuate the switch by pressing it through the deformable blister in order to turn the motor on and observe the operation of the shear in the package.

In another embodiment, the package includes a transparent blister. The blister provides openings through which the purchaser can actuate both the safety button and the power switch in order to turn the motor on and observe the operation of the shear in the package.

### BRIEF DESCRIPTION OF THE DRAWINGS

FIG. 1 is a side elevational view of an electrically-powered grass shear of the present invention.

FIG. 2 is a top plan view of an electrically-powered grass shear of the present invention.

FIG. 3 is a top plan view of an electrically-powered grass shear of the present invention shown with a battery compartment detached from a housing.

FIG. 4 is a top plan view of an electrically-powered grass shear of the present invention in a sealed package designed to allow a potential purchaser to momentarily operate the shear in the package.

FIG. 5 is a side elevational view of the electrically-powered grass shear shown in FIG. 4.

FIG. 6 is a side elevational view of an electrically-powered grass shear of the present invention in a sealed package, showing a cross section of the package, which is designed to allow a potential purchaser to momentarily operate the shear in the package.

FIG. 7 is a side elevational view of an electrically-powered grass shear of the present invention being connected to an extension handle.

### DETAILED DESCRIPTION

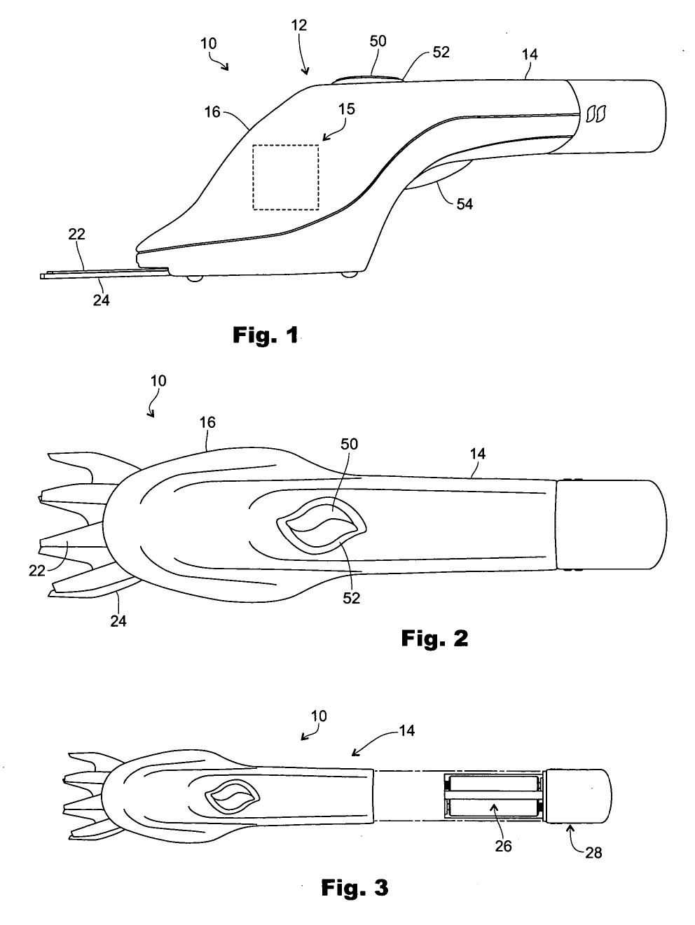

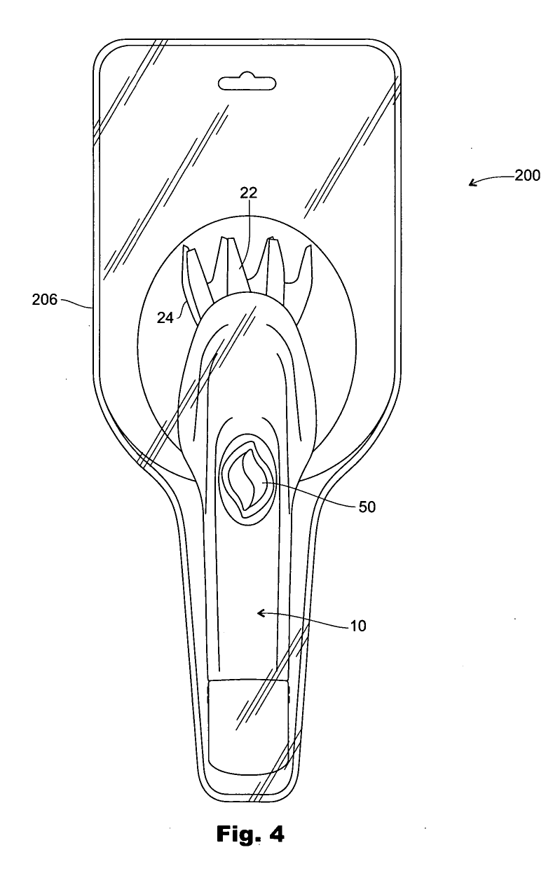

Referring to FIGS. 1-3, there is shown an electrically-powered grass shear 10 of the present invention. Grass shear 10 has a housing 12 comprising a handle portion 14 and a motor housing portion 16 that projects downward at an angle from the handle portion 14. A direct current (“DC”) motor 15 is disposed within motor housing portion 16.

A movable blade 22 and a fixed blade 24 are disposed at the front of motor housing portion 16. Movable blade 22 is linked to motor 15 by power transmission means (not shown) disposed within motor housing portion 16 for converting the rotary motion of motor 15 to an oscillatory or arcuately reciprocating motion and transmitting the motion to movable blade 22, in accordance with previously known technology.

Motor 15 is powered by batteries 26 contained within a battery compartment 28 in handle portion 14. Batteries 26 are electrically connected to motor 15 via a push button-type power switch 50 positioned on top of and toward the front of handle portion 14, where it is easily accessible to the thumb of a user. Battery compartment 28 may be configured to house extra blades 22, 24.

Batteries 26 powering motor 15 may be either rechargeable or non-rechargeable. If rechargeable batteries are used, a jack (not shown) is provided in handle portion 14 for plugging in a charger (not shown) to recharge the batteries from household current.

In a preferred embodiment, power switch 50 is a momentary contact switch that springs up again when pressure on the switch is released. In the preferred embodiment shown, handle portion 14 includes a raised collar 52 around power switch 50 to help prevent accidental actuation.

A safety button 54 is provided on the underside of handle portion 14, where it can be conveniently pressed by the index finger of a user grasping the handle portion 14. Safety button 54 must be pressed before power switch 50 can be actuated to allow current to flow from batteries 26 to motor 15, thus providing additional protection against accidental activation of motor 15. In a preferred embodiment, safety button 54 must remain pressed during actuation of power switch 50. When power switch 50 is released, operation of the grass shear 10 ceases.

A function of safety button 54 is to avoid inadvertent actuation by, for example, placing the tool on a surface with power switch 50 side down. It would be possible for power switch 50 to actuate grass shear 10 alone, except for the requirement of engaging safety button 54. Without safety button 54, grass shear 10 could accidentally run in the inverted position, due to the weight of grass shear 10 pressing on power switch 50. While collar 52 is designed to prevent, to some extent, that particular occurrence, if the surface upon which grass shear 10 is inadvertently laid is irregular, collar 52 may not be effective in preventing accidental actuation. Thus, the position of safety button 54 underneath and opposite power switch 50 requires the user's thumb to operate power switch 50 and forefinger or other finger to grip the barrel of housing 12, so that the safety button 54 is depressed simultaneously with power switch 50 in order to operate grass shear 10.

Referring to FIGS. 4-6, grass shear 10, with batteries 26 installed, is packaged for sale in a sealed package having features that permit a prospective purchaser to momentarily operate grass shear 10 while it is still in the package. This “try-me” feature allows a shopper to observe the operation of grass shear 10 before purchasing it, thus providing an advantage over packaging without such a feature.

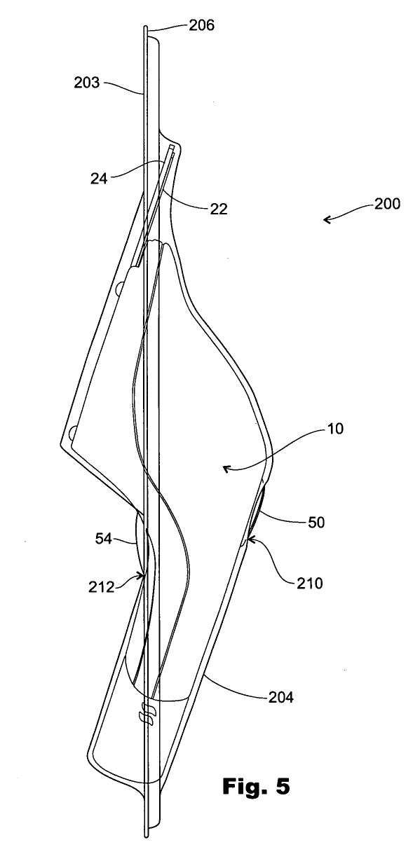

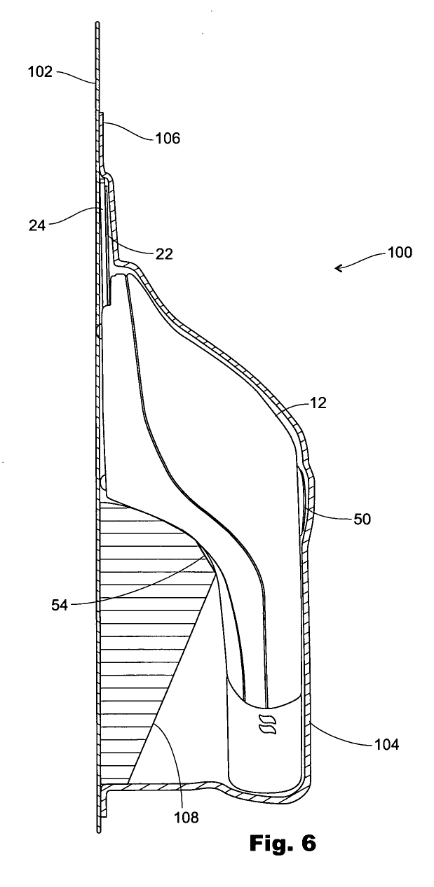

In one embodiment shown in FIGS. 4 and 5, a package, generally designated as 200, comprises a transparent front blister portion 204 and a transparent back blister portion 203. Front blister portion 204 and back blister portion 203 are manufactured using materials and methods well-known in the packaging art. Front and back blister portions 204, 203 are generally molded to conform to contours of grass shear 10. Front and back blister portions 204, 203 have sidewalls dimensioned so that when grass shear 10 is placed between the front and back blister portions 204, 203, the sidewalls are bonded by means known in the art to a generally flat outer perimeter flange-like portion 206 of package 200 such that grass shear 10 is held securely within package 200 with minimal space to move. However, to facilitate the “try-me” feature, it is necessary that the part of package 200 containing the shear blades 22, 24 be wide enough to accommodate the full range of motion of movable blade 22. A power switch opening 210 is positioned in front blister portion 204 to align with power switch 50 to permit a potential purchaser to press and actuate power switch 50. A safety opening 212 is positioned in back blister portion 203 to align with safety button 54 to permit a potential purchaser to press and actuate safety button 54.

In another embodiment shown in FIG. 6, the package, generally designated as 100, comprises a backing card 102 and a transparent blister portion 104. Backing card 102 and blister portion 104 are manufactured using materials and methods well-known in the packaging art. Blister portion 104 is generally molded to conform to the top contours of grass shear 10 and has sidewalls dimensioned so that when grass shear 10 is placed into the blister portion 104, the backing card 102 can be laid flat across the blister portion and bonded by means known in the art to a generally flat outer perimeter flange-like portion 106 of blister portion 104 such that grass shear 10 is held securely within blister portion 104 with minimal space to move. However, to facilitate the “try-me” feature, it is necessary that the part of blister portion 104 containing the shear blades 22, 24 be wide enough to accommodate the full range of motion of movable blade 22. The portion of blister portion 104 over power switch 50 must be pliable enough to permit a potential purchaser to press blister portion 104 down far enough to actuate power switch 50. Ideally, blister portion 104 is manufactured of a shape-retaining material that will spring back to its original contours after it has been pressed down to actuate power switch 50.

Since grass shear 10 is equipped with safety button 54 that must be pressed in order to turn on motor 15, a safety button block 108 is enclosed in package 100 between backing card 102 and housing 12. Safety button block 108 is preferably made of a relatively rigid, lightweight material, such as rigid plastic or foam, and is sized and shaped to fit securely between backing card 102 and housing 12 such that it holds the safety button 54 in the depressed position while grass shear 10 is in package 100, thus allowing shoppers to turn on motor 15 by simply deforming the blister portion 104 above power switch 50 and pressing power switch 50. Once grass shear 10 is removed from package 100, safety button block 108 no longer presses against the safety button 54 and grass shear 10 is restored to full functionality.

Those skilled in the art will appreciate that the blister packages described above are only two potential embodiments of such a “try-me” package. Other types of packaging, including, without limitation, a “clamshell-type” package, may also be provided with such a “try-me” feature within the scope of the present invention and any claims appended hereto.

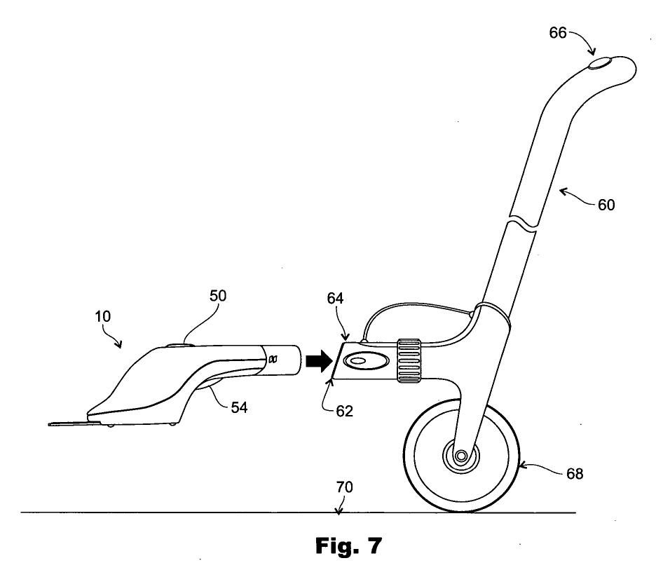

Referring to FIG. 7, in yet another embodiment, the grass shear 10 is provided with an optional extension handle 60 to which grass shear 10 can be removably mounted via a coupling or socket 62 to facilitate use of grass shear 10 while the user is standing. An electrical jack 64 is provided to connect the electrical circuit of grass shear 10 to a switch 66 at the top end of the extension handle, such that power switch 50 can be by-passed when extension handle 60 is used. When grass shear 10 is inserted into extension handle 60, safety button 54 is engaged, so that the user can activate motor 15 by pressing switch 66 on extension handle 60. A wheel 68 may extend from a bottom end of extension handle 60 to assist in supporting grass shear 10 on a surface 70.

The descriptions set forth herein describe and explain the principle, preferred construction, and mode of operation of the present invention, and illustrate and describe what we now consider to represent its best embodiments. However, it should be understood that various changes in the details, materials, and arrangements of parts or the method described herein may be made by those skilled in the art within the principle and scope of the present invention.

What is claimed is:

1. An electric grass shear comprising:
a housing comprising a handle portion and a motor housing portion;
a motor contained within said motor housing portion;
means to supply electric power to said motor;
a power switch configured to control a flow of said electric power to said motor;
a fixed blade having a multiplicity of forwardly-projecting, laterally spaced-apart teeth disposed on said motor housing portion;
a movable blade also having a multiplicity of forwardly-projecting laterally spaced-apart teeth associated with said fixed blade;
means for converting rotary motion from said motor to non-rotary motion and for transmitting said motion to said movable blade, wherein the type of non-rotary motion is chosen from the group consisting of lateral-oscillating motion and arcuately-reciprocating motion, such that operation of said motor causes said movable blade to move across said fixed blade, thereby cutting vegetation between the teeth of said blades; and
a safety button linked to the power switch such that said safety button must be pressed before said power switch can be actuated to allow electric current to flow to the motor.

2. The grass shear of claim 1, wherein the means to supply electric power to the motor comprises batteries.

3. The grass shear of claim 2, further comprising a battery compartment in the handle portion, the battery compartment houses the batteries.

4. The grass shear of claim 1, wherein said grass shear is packaged in a sealed package having a feature that permits a prospective purchaser to momentarily operate the shear while it is still in the package, said package including means for constantly depressing the safety button while said shear is in said package.

5. The grass shear of claim 1, wherein the housing further comprises a raised collar around the power switch.

6. The grass shear of claim 1, further comprising:
a wheeled extension handle having an electrical switch at a top end of said extension handle;
means to removably attach said grass shear to said extension handle; and
means to electrically connect the motor and the means for supplying electricity to said motor to said electrical switch at said top end of said handle, such that said motor can be turned on by actuating said electrical switch.

7. A method of using an electric shear, comprising the steps of:
activating a safety button; and
subsequently activating a power switch while the safety button is activated to allow operation of the shear.

8. The method of claim 7, further including the steps of:
attaching a wheeled extension handle to the shear, wherein the wheeled extension handle is electrically connected to the shear; and
supporting a wheel of the wheeled extension handle on a surface.

9. An electric shear, comprising:
a housing including a handle portion and a motor housing portion;
a motor contained within said motor housing portion;
a power supply in electrical communication with said motor;
a power switch configured to control a flow of electric power from said power supply to said motor;
a fixed blade having a plurality of fixed teeth disposed on said motor housing portion;
a movable blade having a plurality of movable teeth disposed on said motor housing portion such that said plurality of movable teeth are substantially parallel in an over-lapping manner to said plurality of fixed teeth; and
a safety button linked to the power switch such that said safety button must be actuated before said power switch can be actuated to allow said flow of electric power from said power supply to said motor,
wherein rotary motion from said motor is converted to non-rotary motion, said non-rotary motion is transmitted to said movable blade, such that operation of said motor causes said movable blade to move across said fixed blade.

10. The shear of claim 9, wherein the power supply is batteries.

11. The shear of claim 10, further including a battery compartment in the handle portion, wherein said battery compartment houses said batteries.

12. The shear of claim 9, wherein said grass shear is packaged in a sealed package having a feature that permits a user to momentarily operate the shear while it is still in the package

13. The shear of claim 12, further including a power switch opening aligned with said power switch and a safety button opening aligned with said safety button, wherein said user can actuate the safety button through the safety button opening and said user can actuate the power switch through the power switch opening.

14. The shear of claim 12, wherein said package includes a member configured to constantly depress said safety button while said shear is in said package.

15. The shear of claim 9, wherein said housing further comprises a raised collar around said power switch.

16. The shear of claim 9, further including:
an extension handle having a top end and a bottom end;
a wheel extending from said bottom end;
an electrical switch positioned at said top end and in electrical communication with said motor; and
a coupling configured to removably attach said grass shear to said extension handle,
wherein activation of said electrical switch controls said flow of electric power from said power supply to said motor, and
said shear is supportabe on a surface via said wheel.

17. The shear of claim 9, wherein said safety button must remain actuated during actuation of said power switch to maintain said flow of electric power from said power supply to said motor.

18. The shear of claim 9, wherein said power switch is positioned on a top side of said housing, and said safety button is positioned on a bottom side of said housing.
